(19) United States
(12) Patent Application Publication
(10) Pub. No.: US 2007/0157403 A1
(43) Pub. Date: Jul. 12, 2007

(54) Means for driving at least one bristle carrying shaft of a toothbrush

(75) Inventor: Gerardus Johannes Henricus Roddeman, Son en Breugel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,669

(22) PCT Filed: Jan. 31, 2005
(86) PCT No.: PCT/IB05/50403

§ 371 Date: Aug. 3, 2006

(30) Foreign Application Priority Data
Feb. 9, 2004 (EP) 04100474.8

(51) Int. Cl. A61C 17/22

(52) U.S. Cl. 15/22.1

(57) ABSTRACT

Means for driving bristle carrying shafts (21, 22) of a toothbrush comprise a four-lobed cam (33) which is driven by means of an electric motor (30). At opposite sides, the cam is contacted by rollers (34, 35), which are connected to the bristle carrying shafts through arms (25, 26). The rollers are pressed against the cam by means of a spring (27) interconnecting the arms. During operation, a rotation of the cam leads to opposite reciprocating displacements of the rollers. These displacements lead to opposite reciprocating rotations of the bristle carrying shafts about their longitudinal central axes, through the arms. Consequently, bristles which are arranged at an end of the bristle carrying shafts are rotated in opposite rotational directions, in a reciprocating manner. As the number of lobes of the cam is four, the bristles are rotated at a frequency which is four times the frequency at which the cam is rotated.

The present invention relates in general to means for driving at least one bristle carrying shaft of a toothbrush.

It is commonly known that a toothbrush comprises at least one bristle for contacting teeth of a user of the toothbrush. In a toothbrush comprising driving means, the bristle is arranged at one end of a bristle carrying shaft, another end of which being in communication with the driving means. The driving means usually comprise an electric motor having a drive shaft, wherein a battery is arranged for supplying power to the electric motor.

In WO 03/070122, a toothbrush comprising an electric motor and a battery is described. In this toothbrush, a three-lobe cam is mounted on the drive shaft of the electric motor, and a fork having two arms is mounted on the bristle carrying shaft, wherein the cam is accommodated between the arms of the fork. In this way, a rotational movement of the drive shaft brings about a reciprocating rotational movement of the bristle carrying shaft, and of the bristle arranged at an end of the bristle carrying shaft. As the cam comprises three lobes, the frequency of the reciprocating rotational movement of the bristle is three times the frequency of the rotational movement of the drive shaft. Consequently, during operation of the toothbrush, the bristle is moved at a relatively high frequency, which enables a user to obtain good results in a process of brushing his or her teeth.

Despite of the fact that good cleaning results may be obtained by applying the toothbrush known from WO 03/070122, there is a need to improve a few aspects of this toothbrush. For example, there is a need for minimising reaction forces, which are exerted on a housing of the toothbrush during operation of the toothbrush.

According to the present invention, improved driving means for driving at least one bristle carrying shaft of a tooth brush are proposed, which driving means comprise the following driving elements:

two driving arms, wherein each driving arm is arranged such as to be rotatable about a rotation axis which is situated at one end of the driving arm; and

at least one arm actuating member for bringing about reciprocating rotational movements of the driving arms in opposite rotational directions.

The driving means according to the present invention comprise two driving arms and at least one arm actuating member. Each driving arm is arranged such as to be rotatable about a rotation axis which is situated at one end of the driving arm, while the at least one arm actuating member serves for bringing about reciprocating rotational movements of the driving arms in opposite rotational directions.

The driving means may for example comprise an electric motor, wherein the arm actuating member comprises a drive shaft of the motor, but that does not alter the fact that the driving means may comprise other suitable driving elements.

Due to the fact that the driving means according to the present invention comprise two driving arms, it is possible to use the driving means for the purpose of driving two bristle carrying shafts. Therefore, the driving means according to the present invention may be applied in a toothbrush having two bristles and two bristle carrying shafts. Normally, in such a toothbrush, the two bristle carrying shafts extend parallel with respect to each other, wherein they may be arranged next to each other, or in a concentric manner. The ends of the bristle carrying shafts may be arranged such that one bristle is a continuation of the other bristle.

In order to enable the driving means to drive the two bristle carrying shafts, each driving arm is connected to another one of the bristle carrying shafts. Preferably, each driving arm is connected to the respective bristle carrying shaft in such a way that the rotation axis about which the driving arm is rotatable coincides with the longitudinal central axis of the bristle carrying shaft. In such an arrangement, a reciprocating rotational movement of the driving arm about the rotation axis brings about a reciprocating rotational movement of the bristle carrying shaft about its longitudinal central axis, as well as a reciprocating rotational movement of the bristle. Further, movements of the two driving arms in opposite rotational directions bring about movements of the two bristle carrying shafts in opposite rotational directions, as well as movements of the bristles in opposite rotational directions.

On the basis of the preceding paragraphs it will be clear that it is very well possible to apply the driving means according to the present invention for the purpose of a cleaning teeth by means of two bristles which are performing reciprocating rotational movements in opposite rotational directions.

In general, in view of the obtained cleaning results, the application of two bristles is preferred to the application of only one bristle. Furthermore, in case of the two bristles performing movements in opposite rotational directions during operation, an arrangement in which one bristle is a continuation of the other bristle is preferred to an arrangement in which the bristles are arranged next to each other (which is for example known from U.S. Pat. No. 5,864,911), in view of the safety.

In a preferred embodiment, the driving means according to the present invention comprise an electric motor having a drive shaft, wherein a four-lobed cam is arranged at an end of the drive shaft. For the purpose of contacting the cam, two rollers are provided. Each roller is rotatably arranged at an end of another one of the driving arms, which end is opposite to the end where the rotation axis about which the driving arm is rotatable is situated. The driving arms are arranged such that one roller is positioned at one side of the cam, whereas the other roller is positioned at an opposite side of the cam. In order to ensure that the rollers are pressed against the cam, the two driving arms are interconnected by means of a spring.

During operation of the driving means according to the preferred embodiment as described in the preceding paragraph, the drive shaft and the cam are rotated. As the rollers are pressed against opposite sides of the cam, the rollers are rotated as well, and are also displaced, in a way which is determined by the shape of the cam. In the process, the displacements of the rollers bring about rotations of the driving arms about their rotation axes. According to an important aspect of the present invention, the cam shape is chosen such that the rollers perform similar movements in opposite directions, wherein the movements are of a reciprocating nature, whereby the driving arms are forced to perform similar reciprocating rotational movements in opposite rotational directions.

During operation of the driving means according to the preferred embodiment as described in the preceding paragraphs, the driving arms and the rollers move in opposite directions. An advantageous consequence of this fact is that reaction forces which are associated with the masses of the driving arms and the rollers and their movements counterbalance each other. In case of the driving means being accommodated in a housing of a toothbrush, the housing is not subjected to any reaction forces. Further, the drive shaft is symmetrically loaded, as the force exerted by one roller at one side of the drive shaft is counterbalanced by the force exerted by the other roller at the opposite side of the drive shaft.

Another advantage of the driving means according to the preferred embodiment as described in the preceding paragraphs is that these driving means are capable of moving bristle carrying shafts and associated bristles at a frequency which is four times the frequency of the rotational movement of the drive shaft, due to the fact that the cam comprises four lobes. Consequently, the frequency of the movements of the bristles is relatively high, which is advantageous in view of realizing an effective cleaning process.

The present invention also relates to a toothbrush comprising at least one bristle carrying shaft, at least one bristle, and driving means for driving the at least one bristle carrying shaft.

The present invention will now be explained in greater detail with reference to the figures, in which similar parts are indicated by the same reference signs, and in which:

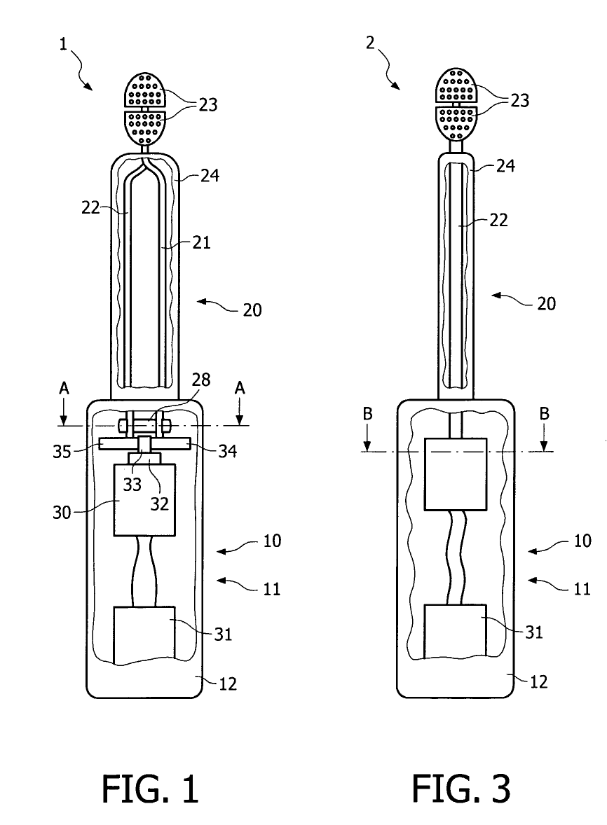

FIG. 1 diagrammatically shows a top view of a toothbrush according to a first preferred embodiment of the present invention, wherein an outer shell of the toothbrush has been partly removed;

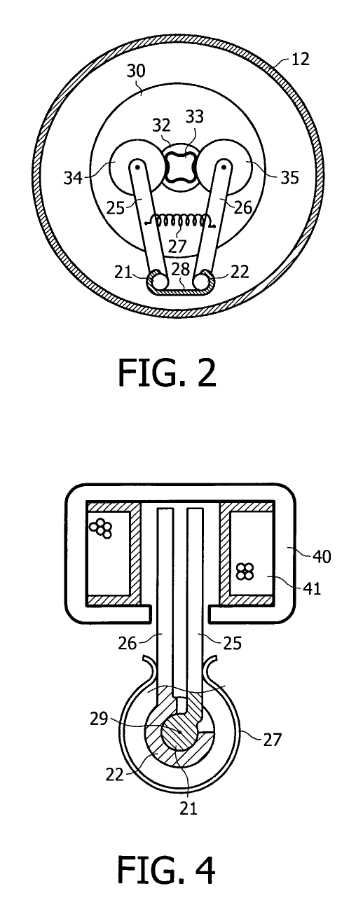

FIG. 2 diagrammatically shows a view of a section along line A-A in FIG. 1;

FIG. 3 diagrammatically shows a top view of a toothbrush according to a second preferred embodiment of the present invention, wherein an outer shell of the toothbrush has been partly removed;

FIG. 4 diagrammatically shows a first possible view of a section along line B-B in FIG. 3;

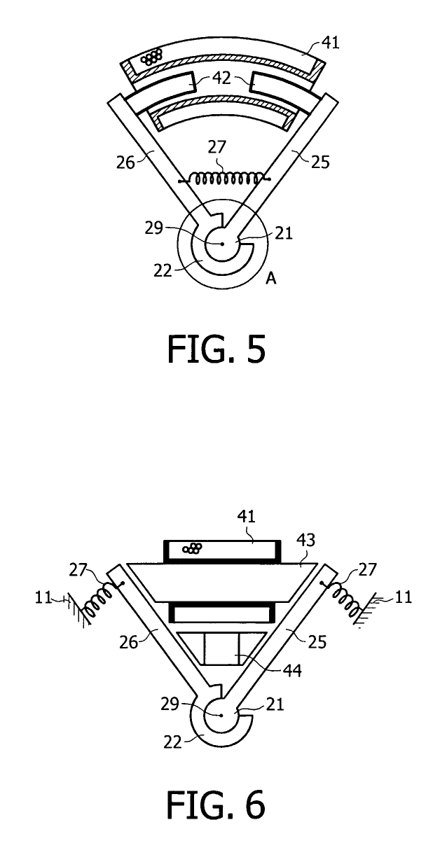

FIG. 5 diagrammatically shows a second possible view of a section along line B-B in FIG. 3;

FIG. 6 diagrammatically shows a third possible view of a section along line B-B in FIG. 3;

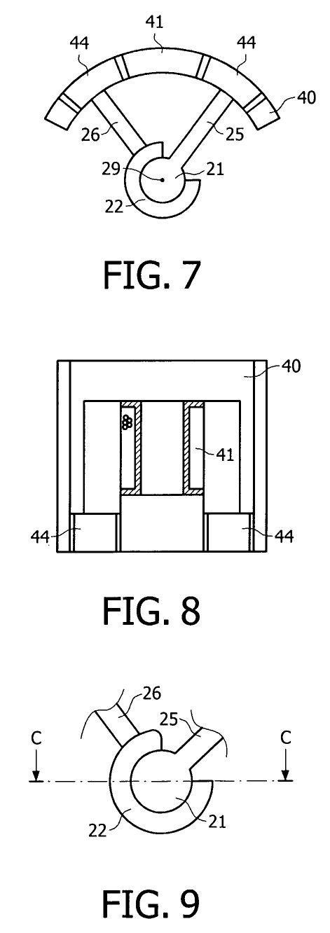

FIG. 7 diagrammatically shows a fourth possible view of a section along line B-B in FIG. 3;

FIG. 8 diagrammatically shows a top view of elements as shown in FIG. 7;

FIG. 9 diagrammatically shows a possible front view of detail A of FIG. 5;

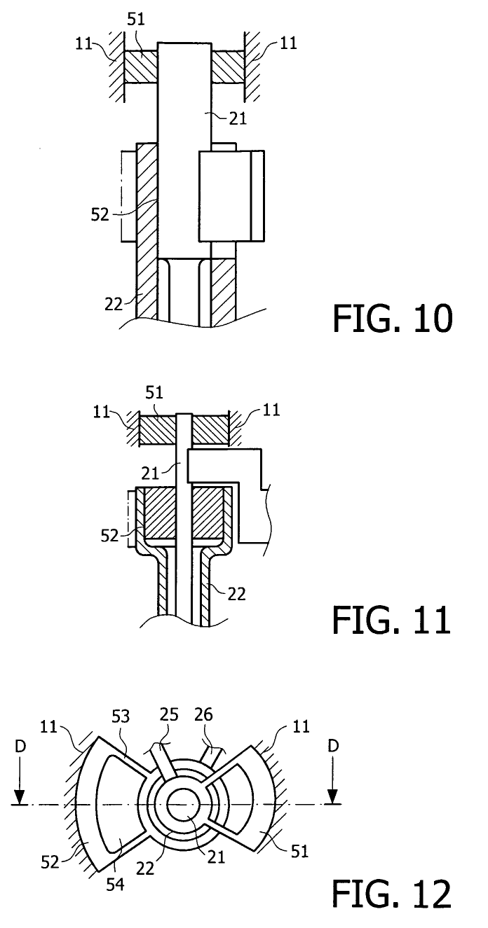

FIG. 10 diagrammatically shows a first possible view of a portion of a section along line C-C in FIG. 9;

FIG. 11 diagrammatically shows a second possible view of a portion of a section along line C-C in FIG. 9;

FIG. 12 diagrammatically shows a first possible back view of detail A of FIG. 5;

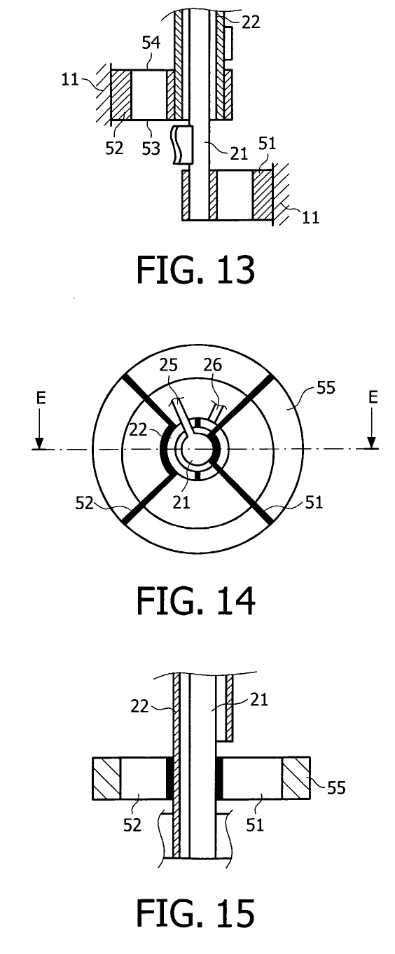

FIG. 13 diagrammatically shows a view of a portion of a section along line D-D in FIG. 12;

FIG. 14 diagrammatically shows a second possible back view of detail A of FIG. 5; and

FIG. 15 diagrammatically shows a view of a portion of a section along line E-E in FIG. 14.

In FIGS. 1 and 2, a toothbrush 1 according to a first preferred embodiment of the present invention is diagrammatically shown. The first toothbrush 1 comprises a handle 10, and a brushing portion 20 connected thereto.

The brushing portion 20 comprises two bristle carrying shafts 21, 22 extending next to each other, substantially parallel with respect to each other. At free ends of both bristle carrying shafts 21, 22, bristles 23 are arranged, in such a way that one bristle 23 is a continuation of the other bristle 23. The bristle carrying shafts 21, 22 are covered by means of an outer shell 24.

The handle 10 comprises a housing 11 for accommodating various elements of the first toothbrush 1, which serve for driving the bristle carrying shafts 21, 22, in a way which will become apparent from the following description of these elements and their functions. A portion of the bristle carrying shafts 21, 22 extends inside the handle 10, where the bristle carrying shafts 21, 22 are connected to the driving elements. The housing 11 comprises an outer shell 12 for covering said portion of the bristle carrying shafts 21, 22 and the driving elements. For the sake of simplicity, bearing means for bearing the driving elements, which bearing means are connected to the housing 11, are not shown in FIGS. 1 and 2.

It will be clear that the handle 10 does not only serve for accommodating the various elements which are used for driving the bristle carrying shafts 21, 22. The handle 10 also enables a user to hold the first toothbrush 1 in his or her hand, in a convenient manner.

Advantageously, the brushing portion 20 is connected to the handle 10 in a detachable manner, so that a used brushing portion 20 may be replaced by a new brushing portion 20, for example in case the bristles 23 are obsolete. Alternatively, it also possible that the bristles 23 are detachable from the bristle carrying shafts 21, 22, so that it is not needed to replace a substantial portion of the bristle carrying shafts 21, 22 together with the bristles 23.

The first toothbrush 1 comprises an electric motor 30, which is connected to a battery 31 for actually providing the power which is needed to drive the bristle carrying shafts 21, 22. The battery 31 is preferably of the rechargeable type. Both the motor 30 and the battery 31 are fixedly connected to the housing 11. That does not alter the fact that the first toothbrush 1 may comprise means for disconnecting the battery 31 from the housing 11, in order to create a possibility of replacing the battery 31.

The motor 30 comprises a rotatable drive shaft 32. At a free end of the drive shaft 32, a four-lobed cam 33 is arranged. At opposite sides, the cam 33 is contacted by rollers 34, 35, wherein a rotation shaft of a first roller 34 is connected to the first bristle carrying shaft 21 by means of a first roller arm 25, and wherein a rotation shaft of a second roller 35 is connected to the second bristle carrying shaft 22 by means of a second roller arm 26. In order to avoid slip and to reduce the level of noise which may be generated as a result of contact between the cam 33 and the rollers 34, 35, a contact surface of the rollers 34, 35 preferably comprises a suitable material such as rubber, plastic or the like.

The rollers 34, 35 are biased against the cam 33 by means of a spring interconnecting the roller arms 25, 26. The first toothbrush 1 as shown in FIGS. 1 and 2 comprises a helical spring 27, but it is also possible that another type of biasing means is applied, for example a torsion spring or a leaf spring. Further, an elastic connection element 28 is arranged between the ends of the roller arms 25, 26, which are connected to the bristle carrying shafts 21, 22. In this way, play between the said ends of the roller arms 25, 26 on the one hand and bearing means for bearing said ends on the other hand is avoided.

As a result of the design of the first toothbrush 1 as described in the foregoing, the brushes 23 simultaneously perform reciprocating rotational movements in opposite rotational directions during operation of the first toothbrush 1. The way in which these movements of the brushes 23 are realized, is explained in the following.

During operation of the first toothbrush 1, the drive shaft 32 of the motor 30 performs a continuous rotational movement in one direction. Consequently, the cam 33 also performs a continuous rotational movement in one direction, and the position of the lobes of the cam 33 with respect to the rollers 34, 35 continually changes. As the cam 33 comprises an even number of lobes, in this case four, and is mirror symmetrical, the rollers 34, 35 are continually forced to move away from each other and allowed to move towards each other, in an alternating manner. In the process, the rollers 34, 35 perform substantially the same movements in opposite directions. Throughout the process, the rollers 34, 35 are continually pressed against the cam 33 by means of the helical spring 27. Furthermore, throughout the process, the rollers 34, 35 are rotated about their rotation shafts. It will be clear that this is advantageous in view of a reduction of frictional forces.

As a result of the displacements of the ends of the roller arms 25, 26 supporting the rollers 34, 35, the other ends of the roller arms 25, 26, which are connected to the bristle carrying shafts 21, 22, and which are interconnected by means of the connection element 28, are rotated in a reciprocating manner. Consequently, the bristle carrying shafts 21, 22 and the bristles 23 arranged at the free ends thereof are also rotated in a reciprocating manner. Since the ends of the roller arms 25, 26 supporting the rollers 34, 35 are displaced in opposite directions, the other ends of the roller arms 25, 26 and the bristle carrying shafts 21, 22 connected thereto are rotated in opposite directions as well. It will be clear that the same applies to the bristles 23 arranged at the free ends of the bristle carrying shafts 21, 22.

In the shown example, the cam 33 comprises four lobes. As a result, a frequency of the reciprocating rotational movements as performed by the bristles 23 is four times a frequency of the rotational movement as performed by the drive shaft 32 of the motor 30. In this way, it is possible to let the bristles 23 move at a relatively high frequency.

On the basis of the foregoing, it will be clear that during operation of the first toothbrush 1, the bristles 23 simultaneously perform reciprocating rotational movements in opposite rotational directions, at a relatively high frequency. During a process of brushing teeth in which the first toothbrush 1 is applied, the teeth are simultaneously contacted by two bristles 23, which are rotating in opposite directions. Consequently, the teeth are simultaneously subjected to two opposite forces, and the process of brushing teeth takes place in a relatively safe manner.

An important advantage of the design of the first toothbrush 1 is that due to the fact that two sets of rollers 34, 35 and roller arms 25, 26 are applied, reaction forces, which are normally exerted on the housing 11 of the first toothbrush 1 during operation of the first toothbrush 1, are minimised. For that reason, it is possible to apply a relatively light housing 11. Furthermore, the drive shaft 32 of the motor 30 is symmetrically loaded, so bearing means bearing this shaft 32 are symmetrically loaded, whereby the life span of these bearing means is increased.

The level of the noise produced by the first toothbrush 1 during operation is relatively low, as there is hardly any play between the various elements through which the drive shaft 32 of the motor 30 and the bristle carrying shafts 21, 22 are connected, and measures such as the application of the elastic connection element 28 are taken to avoid play between the various elements and their respective bearing means.

It will be understood that within the scope of the present invention, many possible embodiments of the toothbrush exist. In FIG. 3, a toothbrush 2 according to a second preferred embodiment of the present invention is diagrammatically shown. In this second toothbrush 2, the bristle carrying shafts 21, 22 are arranged in a concentric manner, instead of next to each other. For the purpose of the following description of the second toothbrush 2, it is assumed that the first bristle carrying shaft 21 is encompassed by the second bristle carrying shaft 22, but it will be understood that the arrangement of the bristle carrying shafts 21, 22 with respect to each other may as well be the other way round. In FIGS. 4-7, a joint central axis of the bristle carrying shafts 21, 22 is indicated by means of reference numeral 29. Bearing means (as diagrammatically shown in FIGS. 6 and 7) are arranged to bear the bristle carrying shafts 21, 22, wherein the position of the central axis 29 is fixed with respect to a housing 11 of the second toothbrush 2. Further, instead of an electric motor 30 having a drive shaft 32, a cam 33 arranged on a free end thereof, and rollers 34, 35 for contacting the cam 33, the second toothbrush 2 comprises other means for driving the bristle carrying shafts 21, 22.

A first alternative of the design of the means for driving the bristle carrying shaft 21, 22 is diagrammatically shown in FIG. 4. According to this first alternative, driving arms 25, 26 of soft-iron or another suitable metal are provided, which are connected to the bristle carrying shafts 21, 22. Substantial portions of the driving arms 25, 26 are accommodated in a yoke 40 comprising a coil 41, wherein the driving arms 25, 26 are encompassed by the coil 41. Outside the yoke 40, the driving arms 25, 26 are interconnected by means of a leaf spring 27.

During operation, the coil 41 is intermittingly energized by means of electric current. In the periods during which the coil 41 is energized, a magnetic field is generated, as a result of which repulsive forces act on the driving arms 25, 26, and the driving arms 25, 26 are moved away from each other. In the intermediate periods, the driving arms 25, 26 are moved towards each other under the influence of the leaf spring 27. In this way, the driving arms 25, 26 are continually forced to move away from each other and to move towards each other, in an alternating manner.

As a result of the process as described in the preceding paragraph, the bristle carrying shafts 21, 22 are continually moved about the central axis 29 in opposite rotational directions, wherein the rotational movements which are performed by the bristle carrying shafts 21, 22 are of a reciprocating nature.

A second alternative of the design of the means for driving the bristle carrying shaft 21, 22 is diagrammatically shown in FIG. 5. According to this second alternative, driving arms 25, 26 are provided, which are connected to the bristle carrying shafts 21, 22. At free ends of the driving arms 25, 26, core portions 42 of soft-iron or another suitable metal are arranged, which have a curved shape, and which are accommodated in a coil 41, wherein the core portions 42 are encompassed by the coil 41, and wherein the core portions 42 are received by opposite ends of the coil 41. The driving arms 25, 26 are interconnected by means of a helical spring 27.

During operation, the coil 41 is intermittingly energized by means of electric current. In the periods during which the coil 41 is energized, a magnetic field is generated, as a result of which repulsive forces act on the core portions 42, and the driving arms 25, 26 are moved away from each other. In the intermediate periods, the driving arms 25, 26 are moved towards each other under the influence of the leaf spring 27. In this way, the driving arms 25, 26 are continually forced to move away from each other and to move towards each other, in an alternating manner. In the process, the movements of the core portions 42 are not hindered by the coil 41, as the coil 41 is bent in substantially the same manner as the core portions 42.

As a result of the process as described in the preceding paragraph, the bristle carrying shafts 21, 22 are continually moved about the central axis 29 in opposite rotational directions, wherein the rotational movements which are performed by the bristle carrying shafts 21, 22 are of a reciprocating nature.

A third alternative of the design of the means for driving the bristle carrying shaft 21, 22 is diagrammatically shown in FIG. 6. According to this third alternative, metal driving arms 25, 26 are provided, one end of which is connected to the bristle carrying shafts 21, 22, and another end of which is connected to the housing 11 of the second toothbrush 2 by means of a helical spring 27. At a position between the driving arms 25, 26, a coil 41 is arranged, which encompasses a core 43 of soft-iron or another suitable metal, wherein the core 43 extends at both ends beyond the coil 41. Furthermore, at a position between the driving arms 25, 26, a magnet 44 is arranged.

During operation, the coil 41 is intermittingly energized by means of electric current. In the periods during which the coil 41 is energized, a magnetic field is generated, as a result of which both ends of the core 43 exert attractive forces on the driving arms 25, 26, whereby the driving arms 25, 26 are moved towards each other. In the intermediate periods, the driving arms 25, 26 are moved away from each other under the influence of the helical springs 27. In this way, the driving arms 25, 26 are continually forced to move towards each other and to move away from each other, in an alternating manner. In the process, the magnet 44 reduces hysteresis, so that the extent to which the movements of the driving arms 25, 26 are hindered by this phenomenon is reduced.

As a result of the process as described in the preceding paragraph, the bristle carrying shafts 21, 22 are continually moved about the central axis 29 in opposite rotational directions, wherein the rotational movements which are performed by the bristle carrying shafts 21, 22 are of a reciprocating nature.

A fourth alternative of the design of the means for driving the bristle carrying shaft 21, 22 is diagrammatically shown in FIGS. 7 and 8. According to this fourth alternative, driving arms 25, 26 are provided, one end of which is connected to the bristle carrying shafts 21, 22, and another end of which is provided with a magnet 44. Furthermore, a yoke 40 and a coil 41 are provided, wherein the coil 41 is held at a position between the magnets 44 of the driving arms 25, 26 by means of the yoke 40.

During operation, the coil 41 is energized by means of electric current, in such a way that opposite magnetic fields are alternately generated. As a result, the coil 41 alternately exerts attractive forces and repulsive forces on the magnets 44, whereby the driving arms 25, 26 are alternately moved towards each other and away from each other. In this way, reciprocating movements of the bristle carrying shafts 21, 22 about the central axis 29 in opposite rotational directions are realized.

A number of alternatives of the design of the bearing means which are provided for bearing the concentrically arranged bristle carrying shafts 21, 22 will be described in the following, with reference to FIGS. 9-15.

A first alternative of the design of the bearing means is shown in FIG. 10, which diagrammatically shows a first possible view of a portion of a section along line C-C in FIG. 9, wherein FIG. 9 diagrammatically shows a view of a section of the concentrically arranged bristle carrying shafts 21, 22 and a portion of the driving arms 25, 26 connected thereto.

According to the first alternative, the bristle carrying shafts 21, 22 are supported by slide bearings 51, 52, which are preferably very accurate in order to obtain a reduction of the level of generated noise. The first bristle carrying shaft 21 is supported by a first slide bearing 51, which is fixedly connected to the housing 11 of the second toothbrush 2. The second bristle carrying shaft 22 is supported by a second slide bearing 52, which is arranged on the first bristle carrying shaft 21.

A second alternative of the design of the bearing means is shown in FIG. 11, which diagrammatically shows a second possible view of a portion of the section along line C-C in FIG. 9. According to this second alternative, an elastic bearing of the bristle carrying shafts 21, 22 is realized by means of rubber cylinders 51, 52. The first bristle carrying shaft 21 is fixedly connected to a first rubber cylinder 51, which is fixedly connected to the housing 11 of the second toothbrush 2. The second bristle carrying shaft 22 is fixedly connected to a second rubber cylinder 52, which is fixedly arranged on the first bristle carrying shaft 21. In this arrangement, rotational movements of the bristle carrying shafts 21, 22 bring about deformations of the rubber cylinders 51, 52.

A third alternative of the design of the bearing means is diagrammatically shown in FIGS. 12 and 13. According to this third alternative, an elastic bearing of the bristle carrying shafts 21, 22 is realized by means of plastic bearing elements 51, 52 comprising an elastic portion 53 which is provided with a cavity 54. The first bristle carrying shaft 21 is fixedly connected to a first plastic bearing element 51, which is fixedly connected to the housing 11 of the second toothbrush 2. The second bristle carrying shaft 22 is fixedly connected to a second plastic bearing element 52, which is also fixedly connected to the housing 11 of the second toothbrush 2. In this arrangement, rotational movements of the bristle carrying shafts 21, 22 bring about deformations of the elastic portions 53 of the plastic bearing elements 51, 52.

A fourth alternative of the design of the bearing means is diagrammatically shown in FIGS. 14 and 15. According to this fourth alternative, an elastic bearing of the bristle carrying shafts 21, 22 is realized by means of leaf springs 51, 52. Both leaf springs 51, 52 are fixedly connected to a ring 55, which is connected to the housing 11 of the second toothbrush 2, for example through another leaf spring (not shown). The first bristle carrying shaft 21 is fixedly connected to a first leaf spring 51, whereas the second bristle carrying shaft 22 is fixedly connected to a second leaf spring 52. In this arrangement, rotational movements of the bristle carrying shafts 21, 22 bring about deformations of the leaf springs 51, 52.

It will be clear to a person skilled in the art that the scope of the present invention is not limited to the examples discussed in the foregoing, but that several amendments and modifications thereof are possible without deviating from the scope of the present invention as defined in the attached claims.

It is not necessary that the toothbrush 1, 2 according to the present invention comprises two bristles 23. Consequently, it is not necessary that the toothbrush 1, 2 according to the present invention comprises two bristle carrying shafts 21, 22. Instead, it is possible that only one bristle carrying shaft 21, 22 and only one bristle 23 are provided. However, it is preferred to make use of the possibility of obtaining an effective teeth brushing process by means of two bristles 23 performing reciprocating rotational movements in opposite directions, as offered by the present invention.

Although a four-lobed cam 33 has been described in relation to the first toothbrush 1, a cam 33 having another number of lobes may be applied. In order to cause the contacting rollers 34, 35 to be displaced in opposite directions, it is important that the number of lobes is even.

In relation to the first toothbrush 1, it has been described that the ends of the roller arms 25, 26, which are connected to the bristle carrying shafts 21, 22 are joined by an elastic connection element 28. That does not alter the fact that another suitable type of connection element 28 may be applied, wherein it is important that play between the said ends of the roller arms 25, 26 on the one hand and bearing means for bearing said ends on the other hand is avoided.

1. Means for driving at least one bristle carrying shaft of a toothbrush, comprising:
two driving arms, wherein each driving arm is arranged such as to be rotatable about a rotation axis which is situated at one end of the driving arm; and
at least one arm actuating member for bringing about reciprocating rotational movements of the driving arms in opposite rotational directions.

2. Driving means according to claim 1, comprising:
a rotatably arranged cam having an even number of lobes; and
biasing means for biasing the driving arms against opposite sides of the cam.

3. Driving means according to claim 2, wherein a roller for contacting the cam is rotatably arranged at an end of each driving arm, which end is opposite to the end where the rotation axis about which the driving arm is rotatable is located.

4. Driving means according to claim 2, comprising an electric motor having a drive shaft, wherein the cam is arranged at the drive shaft of the electric motor.

5. Driving means according to claim 1, comprising an electric coil for encompassing a substantial portion of the driving arms, wherein the driving arms comprise metal, preferably soft-iron.

6. Driving means according to claim 1, wherein a metal core portion is arranged at an end of each driving arm, which end is opposite to the end where the rotation axis about which the driving arm is rotatable is located, the driving means comprising an electric coil for encompassing a substantial portion of the metal core portions.

7. Driving means according to claim 5, wherein biasing means are provided for biasing the driving arms towards each other.

8. Driving means according to claim 1, comprising an electric coil encompassing a metal core, wherein the driving arms are arranged at both ends of the core.

9. Driving means according to claim 8, wherein biasing means are provided for biasing the driving arms away from each other.

10. Driving means according to claim 1, wherein a magnet is arranged at an end of each driving arm, which end is opposite to the end where the rotation axis about which the driving arm is rotatable is located, the driving means comprising an electric coil, wherein the magnets are positioned on both sides of the coil.

11. Driving means according to claim 1, wherein the rotation axes about which the driving arms are rotatable coincide.

12. Toothbrush, comprising:
at least one bristle carrying shaft which is arranged such as to be rotatable about its longitudinal central axis;
at least one bristle which is arranged at an end of the at least one bristle carrying shaft, and which is intended for contacting teeth of a user of the toothbrush; and
driving means according to claim 1, wherein the at least one bristle carrying shaft is associated to a driving arm of the driving means.

13. Toothbrush according to claim 12, wherein the longitudinal central axis of the at least one bristle carrying shaft coincides with the rotation axis about which the associated driving arm is rotatable.

14. Toothbrush according to claim 12, comprising two bristle carrying shafts and two bristles, wherein the bristles are arranged such that one bristle is a continuation of the other bristle.

15. Toothbrush according to claim 12, comprising two bristle carrying shafts, wherein the longitudinal central axes of the bristle carrying shafts coincide.

16. Toothbrush according to claim 12, wherein the at least one bristle carrying shaft is supported by a slide bearing.

17. Toothbrush according to claim 12, wherein the at least one bristle carrying shaft is supported by a deformable elastic bearing, which is fixedly connected to the at least one bristle carrying shaft.
